(19) United States
(12) Patent Application Publication
(10) Pub. No.: US 2017/0055687 A1
(43) Pub. Date: Mar. 2, 2017

(54) PAINTER'S BELT

(71) Applicant: Jose C. Diaz, Lovettsville, VA (US)

(72) Inventor: Jose C. Diaz, Lovettsville, VA (US)

(21) Appl. No.: 15/254,389

(22) Filed: Sep. 1, 2016

Related U.S. Application Data
(60) Provisional application No. 62/212,742, filed on Sep. 1, 2015.

(51) Int. Cl. A45F 5/02; A41F 9/00; A41D 27/20; B25H 3/00

(52) U.S. Cl. CPC A45F 5/021; B25H 3/00; A41F 9/002; A41D 27/20

(57) ABSTRACT

A painter's tool belt comprising an elongated linear belt member for wrapping around a waist of a user; the belt member provided with a fastener assembly. Mounted on the belt member is a transparent plastic cylindrical open ended caulking gun pouch, a loop member, a hammer loop assembly, a first rectangular transparent plastic pocket with a top opening, a second rectangular transparent plastic cutting tool pocket having a length which is longer than the first rectangular plastic pocket, the second rectangular cutting tool pocket having a top opening positioned above the first rectangular transparent plastic pocket top opening and a transparent plastic paint brush pocket secured to said belt member, the paint brush pocket comprising a flap section and a brush section secured to the flap section, the brush section being formed of a wider upper section and an integral narrower lower section.

### RELATED APPLICATIONS

This is a utility patent application claiming priority and benefit from U.S. Provisional Patent Application No. 62/212,742, filed Sep. 1, 2015.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

1. Field of the Invention

The present invention relates to painter belts for carrying painters tools such as a caulking gun, sand paper, a putty knife, and a paint brush.

2. Description of the Prior Art

A painter must have both a supply of paint and the necessary tools for repairing the area being painted, all of which are immediately accessible at the location to be painted. A surface to be painted may be accessible from the ground which requires the painter to repeatedly stoop to fix the surface and apply the paint. Often it is necessary for the painter to climb a ladder or scaffolding to access the higher surfaces to be painted. The ladder or scaffolding may be unstable and it is often necessary for a painter to have one or both hands free to ascend and descend the ladder although the paint supply and tools must be carried up the ladder and in many cases, are hung from the ladder. In order to paint an interior or exterior surface a painter has to fix surface imperfections prior to applying the paint. Such surface preparations may involve sanding the surface to be painted, applying caulking, spackle, glazing compound, pounding in nail pops, removing loose paint and repainting with a primer. Each of these jobs requires its own unique tool to carry out the specific surface preparation and it is necessary for a painter to have these tools handy so that they can be immediately used when needed. Utility belts are well known for carrying tools and accessories for various specialized workers. Some of these utility belts are specifically designed for painters.

As previously noted, many paint jobs require the painter to climb a ladder or work from scaffolding. Currently, painters hang or place their tools on the ladder. Consequently caulking guns, hammers, putty knives and bladed tools, paint brushes and the like can fall, spreading paint or caulk over the floor of the workplace, causing damage to the flooring or hit workers working below which can cause serious injury. Prior art utility belts do not allow the tools to be readily accessible by the user and easy to replace in their respective holders. Furthermore, prior utility belts have been difficult to clean and maintain, leading to paint, caulk and material coating the tools and buildup of the paint and caulk on the belt itself. Consequently there have been a number of attempts to solve these problems.

U.S. Pat. No. 4,325,503 issued Apr. 20, 1982; U.S. Pat. No. 4,919,317 issued Apr. 24, 1990; U.S. Pat. No. 5,490,618 issued Feb. 13, 1996 and U.S. Pat. No. 6,557,738 issued May 6, 2003 are directed towards paint can holders which are supported by a belt while U.S. Pat. No. 4,746,042 issued May 24, 1988 and U.S. Pat. No. 5,072,868 issued Dec. 17 1991 discloses the use of a portable wet paint brush holder

U.S. Pat. No. 5,385,281 issued Jan. 31, 1995 discloses a painter's utility belt with means for carrying at least one paint can and a variety of additional tools. The belt includes an apron provided with a first loop which may be secured about a paint can below the bail lugs on the sides of the can to support the can from the belt. A second loop is secured to the belt and is wrapped about a section of PVC pipe for the storage of a caulking gun. The belt and loop portions are formed of polypropylene while an apron portion of the belt is formed of canvas. The paint can is positioned at the front of the painter, so that it can in the way when the painter is going up or down a ladder causing spillage or loss of balance. Carrying the heavy paint cans at the painter's front causes stress which may injure the back and/or hips and the disclosed utility belt does not carry the necessary tools for surface preparation.

U.S. Pat. No. 5,695,104 issued Dec. 9, 1997 is directed towards a painter's accessory holder which is constructed with a rectangular flat surfaced base member mounted on a belt to which a caulking gun bracket, a sandpaper bracket, a putty or glazing compound pouch and a bladed tool bracket are attached. One or more belt loops are located on and extend from the opposite side of the base member. The caulking gun bracket has a U shaped configuration and is formed of injection molded plastic or rolled steel.

U.S. Pat. No. 5,943,696 issued Aug. 31, 1999 discloses a belt with a leather apron mounted thereon. The apron has hooks for holding a paint can and holds a paint brush within the paint can. A tool pouch is sewed to the apron and a separate caulking gun pouch is slidably mounted on the belt.

U.S. Pat. No. 6,213,365 issued Apr. 10, 2001 discloses a fabric painter's utility belt with a widened middle portion embedded with lumbar support inserts. Loops are formed along the widened middle portion for holding tools such as a scrapper and screwdrivers. A pocket is centered on the sash for holding a sanding block and a pair of vertical clips closed with buckles are attached near the ends of the sash for holding caulking guns, tape or paint cans which swing from the clips. A pair of D-rings are attached to the webbing of the belt near the opposite ends for holding a hammer, or a rag. A pair of combination pocket assemblies are releasably mounted to the ash and hang from the sash. One combination pocket assembly has a paint pocket lined with a liquid resistant material for holding paint and a plurality of tool packets for holding tools. Each combination pocket also includes loops for holding pail hooks, spray gun handles and the like.

The prior art discloses belts and assemblies which do not provide for the necessary painters tools, are heavy or bulky leading to a wearer's discomfort, do not allow access or replacement of tools and cannot be easily cleaned from paint, caulk and putty spillage.

Therefore, a need exists to provide an improved inexpensive painters belt which will hold the basic tools need in the painters trade and allow easy access and replacement of same. The improved painter's belt is simple to use, allow for wet and dry storage, has easy cleanup and durability and is inexpensive.

### SUMMARY OF THE INVENTION

A painter tool belt is disclosed for holding painting accessory tools such as a caulking gun, cleaning cloths, sandpaper, a bladed tool, a wiping cloth and a paint brush.

The tool belt has an elongated linear belt member for wrapping around a waist of a user with a dual prong buckle on one end and series of throughgoing apertures on the other end. The painter's tool belt has a cylindrical open ended caulking gun pouch, a loop member, and a hammer loop assembly. The hammer loop assembly has a protective support flap secured to the painter's belt and a loop secured to the support flap. The painter's tool belt also has a small rectangular pocket for sand paper and the like and a long rectangular pocket for holding scrapping and cutting instruments. A paint brush pocket is secured to the belt and is made up of two stepped sections, with a wider top section and a narrower bottom section, forming a stepped chamber which is open on both ends which receives a handle of a paint brush and holds the bristle portion of a paint brush.

It is an object of the current invention to provide a painter's belt which will carry all the tools necessary for surface preparation as well as paint application;

It is still a further object of the present invention to provide a painter's belt which is made of a material which is durable, flexible, light weight and absorbent.

It is another object of the invention to provide a painter's belt which has transparent plastic tool holders;

It is a further object of the invention to provide a painter's belt constructed of water and paint resistant material;

It is another object of the invention to provide an improved painter's belt that is simple to use and easily cleaned;

It is yet another object of the invention is to provide an improved painter's belt that can carry a caulking gun, a paint brush, a hammer, a scrapping tool, cleaning rags and a paint brush;

It is still another object of the invention to provide an improved painter's belt having an offset caulking gun holder;

Still another object of this invention is to provide a painter's belt which is adjustable for fitting different user's waist sizes and which is comfortable and durable.

The present invention is directed toward an improved painter's belt which distributes the load of tools evenly on the user.

The invention will be better understood and objects other than those set forth above will become apparent when consideration is given to the following detailed description thereof. Such description makes reference to the annexed drawings herein.

### BRIEF DESCRIPTION OF THE DRAWINGS

FIG. 1 is a top plan view of the inventive painter's belt;

FIG. 2 is a front perspective view of the painter's belt shown in FIG. 1 worn on a user;

FIG. 3 is a rear perspective view of the painter's belt shown in FIG. 1 worn on a user;

FIG. 4 is a right side perspective view of the painter's belt shown in FIG. 1 worn on a user;

FIG. 5 is a left side perspective view of the painter's belt shown in FIG. 1 worn on a user;

FIG. 6 is a partial enlarged plan view of the painter's belt shown in FIG. 1; and

FIG. 7 is a partial enlarged plan view of the remainder of the painter's belt shown in FIG. 1.

### DETAILED DESCRIPTION OF THE INVENTION

While the invention is described in connection with certain preferred embodiments, but it is not intended that the present invention be so limited. On the contrary, it is intended to cover all alternatives, modifications, and equivalent arrangements as may be included within the spirit and scope of the invention as defined by the appended claims.

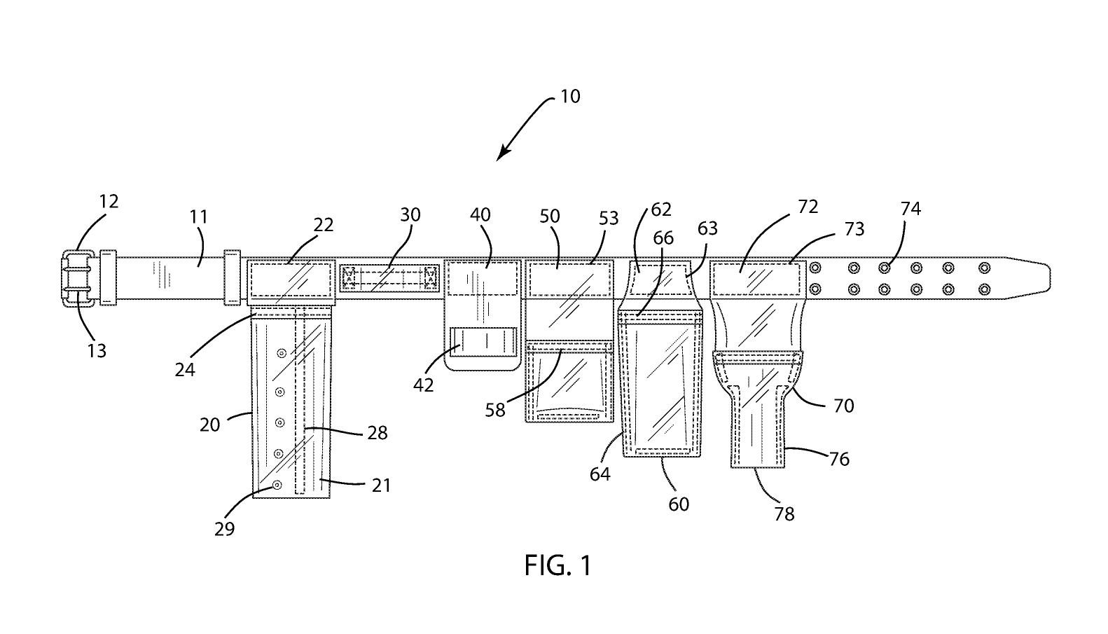

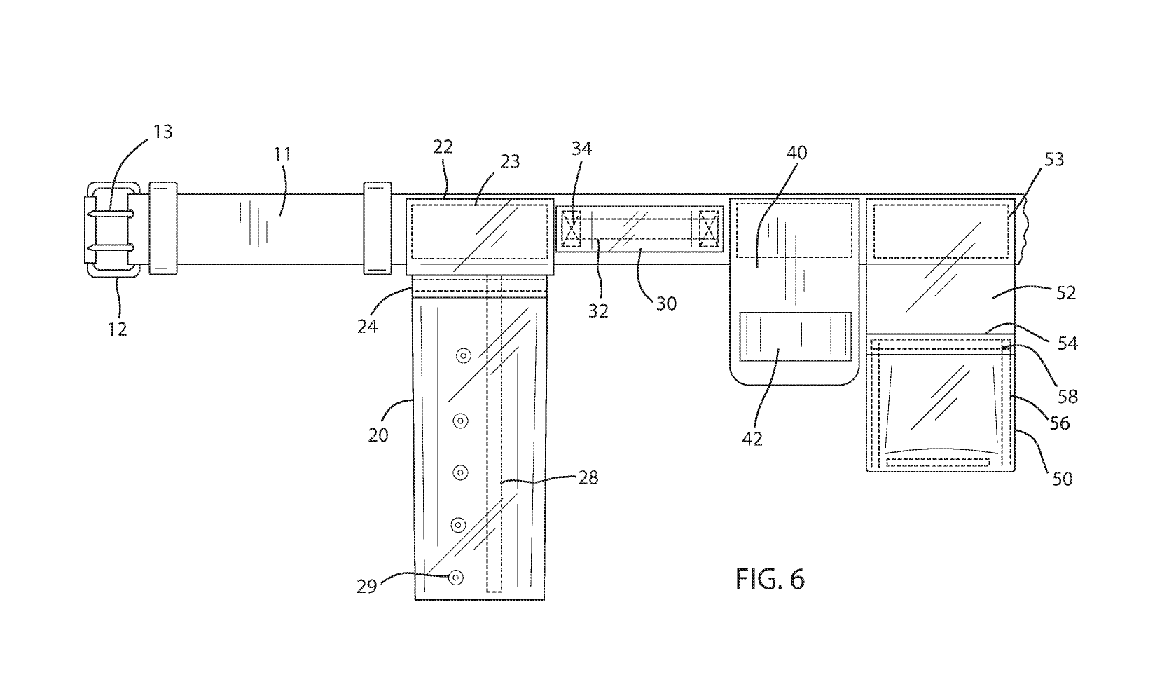

The present invention relates to a painter's belt 10 having different tool compartments with the preferred embodiment and best mode shown in FIGS. 1-7.

Referring to the drawings, the painter's belt 10 is preferably constructed of a belt having a woven nylon linear body 11 with a two pronged buckle 12 fastened at one end of the belt and a series of spaced throughgoing sizing apertures 14 cut into the leading end portion of the belt body 11. The sizing apertures 14 are formed by six linear apertures cut in a row with two spaced parallel rows allowing for a waist variation ranging from 30 inches to 44 inches in waist girth. It is apparent that additional or fewer apertures can be used depending on the waist size range for the wearer. Each aperture is formed with a metal press ring 15 and sized to receive a prong 13 of buckle 12.

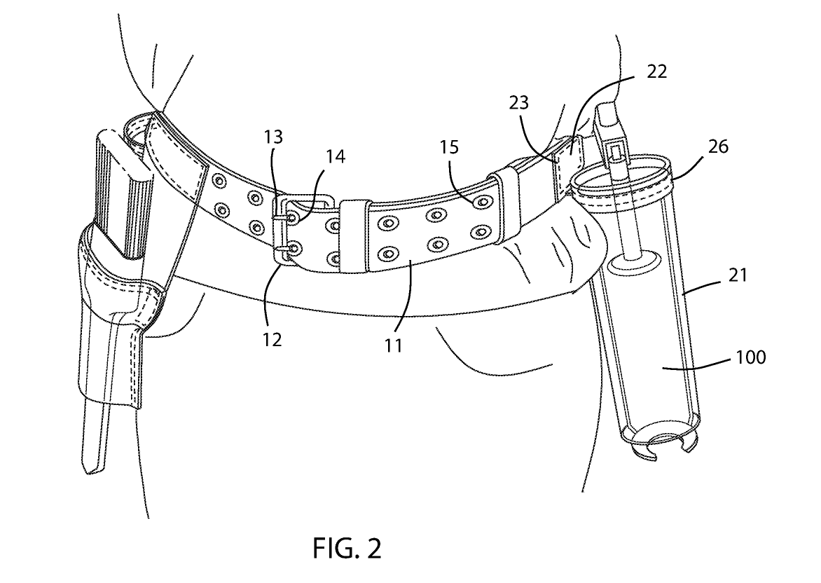

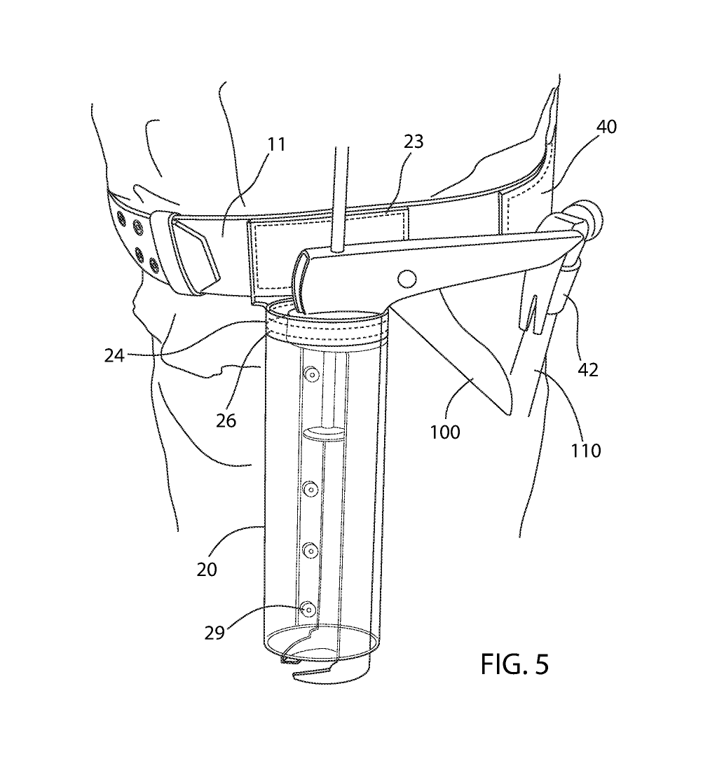

A cylindrical open ended caulking gun holder 20 having a cylindrical body 21 with an upward extending flap member 22 is secured on the belt body 11 by stitching 23 as seen in FIGS. 2, 5 and 6. The flap member 22 allows easy insertion and removal of the caulking gun 100 and is stitched around its outer edges and secured to the belt body 11 as shown in FIG. 5. The proximal end 24 of the cylindrical caulking gun holder 20 is positioned adjacent the bottom section of the flap member 22 and is sewn with two parallel circumferential rows of stitching 26 to provide extra protection and stiffness to the end as the caulking gun is inserted and withdrawn from the holder or holster body 21. The flap member 22 is slightly offset as shown in FIGS. 2, 5 and 6 to keep the caulking gun holder 20 in a substantially vertical position when the caulking gun 100 is removed and inserted into the holder 20. The cylindrical holster body 21 allows a caulking gun 100 to be easily inserted and removed from the caulking gun holder 20 and be positioned with the tube downward. The cylindrical body 21 of the caulking gun holder 20 is sewed with double stitching 28 along its length and is also provided with a linear row of rivets 29 along its length as shown in FIG. 1 to strengthen the cylindrical body 21 and provide better wearing capabilities.

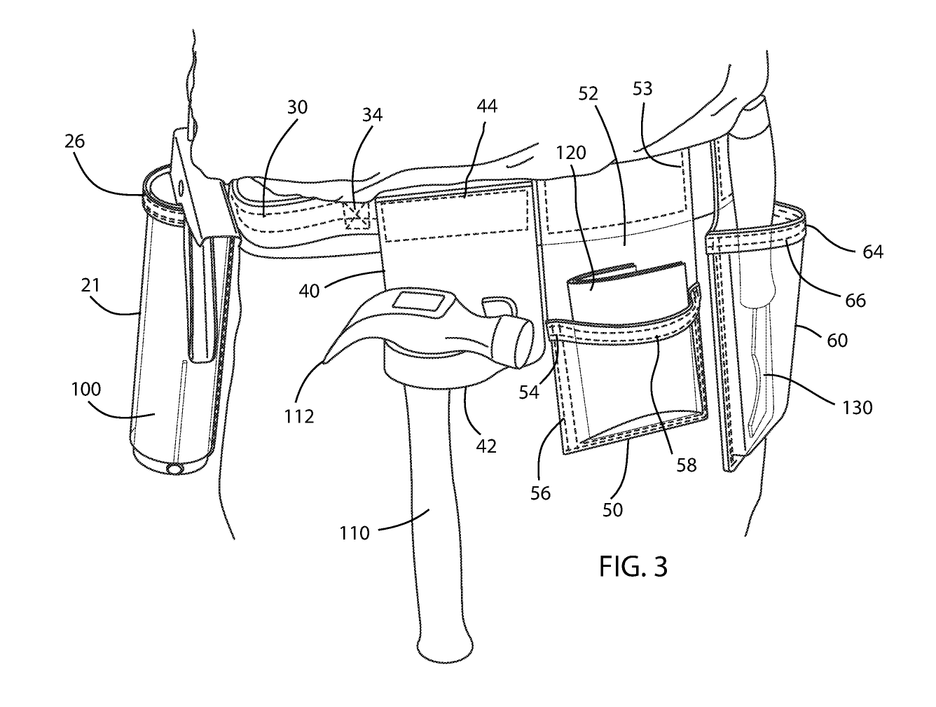

Adjacent the caulking gun holder 20 is a plastic loop member 30 which is secured by stitching at each end to the belt body 11. The plastic loop member 30 is double stitched 32 along its length to provide strength to the loop member and the ends are X stitched 34 as shown in FIG. 3. The loop member 30 is positioned parallel along the belt body and is made of clear plastic and is used to hold rags, and cleaning cloths.

Mounted on the back of the belt body 11 adjacent loop member 30 is a back flap 40 and a hammer loop 42 which is secured to the back flap 40 by stitching. The back flap 40 is mounted to the belt body with a square stitch 44. The back flap 40 provides protection for the wearer against the hammer claw 112 of hammer 110 and limits movement of the hammer when the painter is working or if the painter happens to fall. The hammer loop 42 is positioned below the belt 11 near the bottom of the back flap 40 as seen in FIG. 3.

Adjacent the hammer loop 42 also mounted to the belt body 11 is a rectangular two piece clear plastic sandpaper pocket 50 having a back flap 52 which is secured to the belt body 11 by stitching 53. The sandpaper pocket 50 is open at the top 54 allowing insertion of sandpaper 120 or nails (not shown) into the pocket. The opening 54 is at approximately the hammer head position to allow easy grasping of the sandpaper 120. Flap 52 is square stitched 53 to belt body 11 and pocket 50 is double stitched 56 to flap 52. A single strip pocket top protector 58 is double stitched at the top open end of the pocket 50.

A two piece plastic blade pocket 60 is mounted to the belt body 11 by sewing distally flared back flap 62 of the blade pocket onto the belt body 11 as seen in FIG. 1. The blade pocket 60 has a flared back flap 62 secured to the belt body 11 via a truncated stitch 63 and the pocket 60 is longer in length than the sandpaper pocket 52. The blade pocket is constructed of clear plastic material sewed together with double stitching 64 to hold a scraper 130 or other blade as shown in FIG. 3. A single strip pocket top protector 66 is double stitched at the top open end of the pocket.

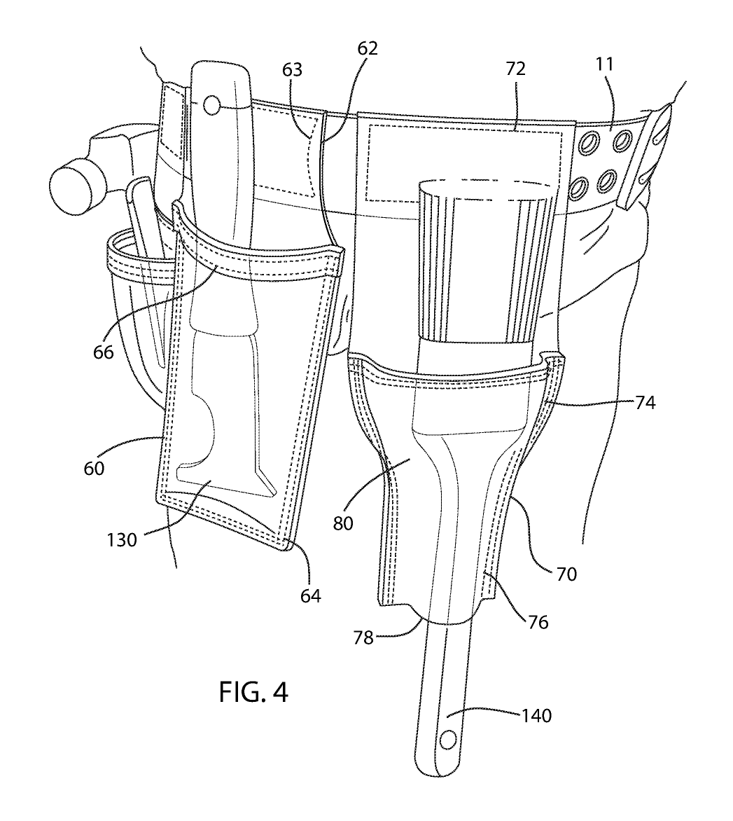

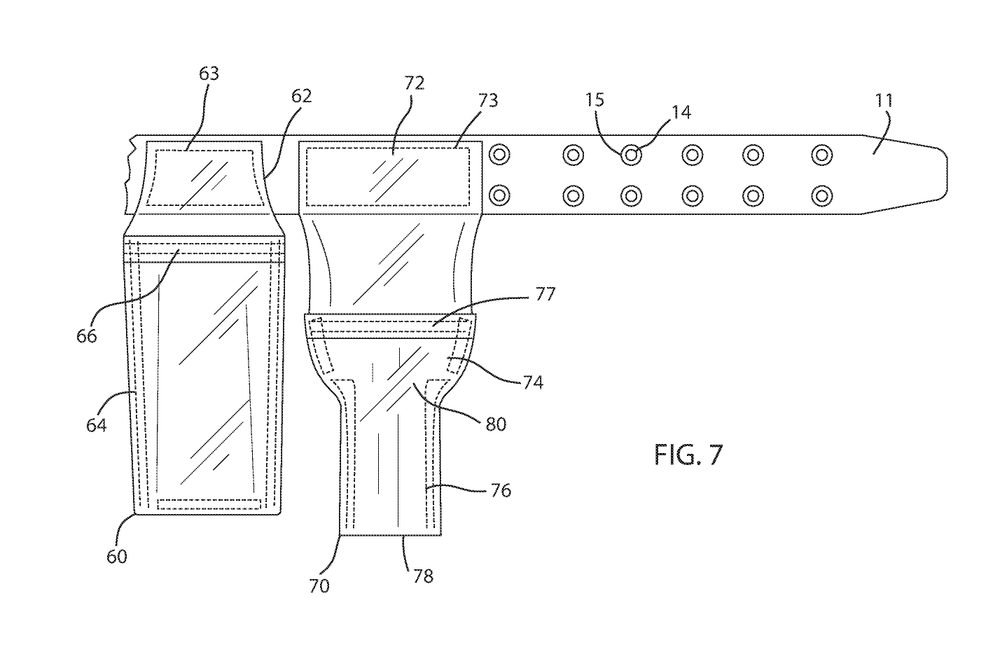

A paint brush pouch 70 is secured to the belt body 11 adjacent the blade pocket 60 by a flap 72 secured to the belt body by a square stitch 73. The paint brush pouch 70 is constructed of a flap 72 secured to two clear plastic pieces formed with an open wider section 74 which holds up to a three inch wide paint brush 140 and a narrower handle section 76 with an open end 78. The narrower section 76 holds the brush handle and allows the brush handle to extend past the open end 78 as seen in FIG. 4. The flap 72 is secured to the belt body 11 with a square stitch pattern. The brush pouch plastic pieces are secured together by double row stitching 77. A two stage or stepped chamber 80 is formed by the wider section 74 and narrower section 76 to as seen in FIGS. 4 and 7. The narrower section 76 receives the handle of the paint brush and the wider section holds the bristle portion of the paint brush. The paint brush 140 is inserted into the paint brush pouch 70 handle first.

The plastic used for the pockets and pouches is transparent allowing viewing of the tools and materials carried therein as well as being able to be easily cleaned. The material used can be any suitable plastic which has the necessary strength and can be sewn together such as polypropylene, polyvinylchloride, or any suitable mixture of same or other suitable anti-stick polymer plastic which can be molded or folded and sewn into the desired shape. Transparent plastic is used because it is easy to clean allowing paint and putty spills to be easily removed and the spilled materials are easily observed.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A painter's tool belt comprising:
an elongated linear belt member for wrapping around a waist of a user, means on said linear belt member allowing it to be removably secured to itself;
a cylindrical open ended caulking gun pouch secured to said belt member;
a hammer loop assembly secured to said linear belt member;
at least one rectangular pocket secured to said belt member; and
an open ended paint brush pouch secured to said belt member, said paint brush pouch comprising two sections, a wider top section and a narrower bottom section forming a stepped chamber open on both ends, said narrower bottom section receiving a handle of a paint brush and the wider top section holding the bristle portion of a paint brush.

2. A painter's tool belt as claimed in claim 1 wherein said pouches and said pockets are made of transparent plastic material.

3. A painter's tool belt as claimed in claim 1 wherein said pouches and said pockets are constructed of two pieces of plastic material secured together, a rear piece defining a rear flap which extends past the pouch body and is secured to said belt member.

4. A painter's tool belt as claimed in claim 1 wherein said belt includes a plastic loop member secured to said belt member.

5. A painter's belt as claimed in claim 1 wherein, said hammer loop assembly comprises a flap member secured to said belt member, and a loop secured to said flap member.

6. A painter's belt as claimed in claim 1 wherein said paint brush pouch defines an open wider upper portion and an open narrower lower portion.

7. A painter's belt as claimed in claim 6 wherein said narrower neck portion defines an opening sufficient to allow a paint brush handle to be inserted therein and extend therethrough.

8. A painter's belt as claimed in claim 1 wherein said paint brush pouch sections define a stepped chamber open at both ends.

9. A painter's belt as claimed in claim 2 wherein said plastic material is taken from a group consisting of polypropylene, polyvinyl chloride or anti-stick polymer plastic which can be molded.

10. A painter's tool belt comprising:
an elongated linear belt member for wrapping around a waist of a user; said belt member being provided with a buckle on one end and series of throughgoing apertures on the other end;
a cylindrical open ended caulking gun pouch secured to said linear belt member;
a loop member secured to said linear belt member;
a hammer loop assembly secured to said linear belt member, said hammer loop assembly comprising a support flap secured to said belt member and a loop member secured to said support flap;
a first rectangular pocket with a top opening secured to said belt member;
a second rectangular cutting tool pocket longer than said first rectangular pocket secured to said belt member with an opening of said pocket being positioned above said first rectangular pocket opening; and
a paint brush pouch secured to said belt member, said paint brush pocket comprising two pieces of plastic fastened together to form two sections, a wider top section and a narrower bottom section, said sections forming a stepped chamber open on the wider top section and the narrower bottom section which receive a handle of a paint brush and hold the bristle portion of paint brush.

11. A painter's belt as claimed in claim 10 wherein each pouch and pocket have a flap member which is secured to said belt member.

12. A painter's belt as claimed in claim 10 wherein said bottom portion of said paint brush pouch defines an opening having an area large enough to allow a paint brush handle to be inserted therein.

13. A painter's belt as claimed in claim 10 wherein, said pouches and pockets are made of clear plastic.

14. A painter's belt as claimed in claim 10 wherein said loop member and said hammer loop assembly are constructed of clear plastic.

15. A painter's belt as claimed in claim 10 wherein, said pouches and pockets are constructed of two pieces of plastic stitched together.

16. A painter's tool belt comprising:
an elongated linear belt member for wrapping around a waist of a user; said belt member being provided with a buckle on one end and series of throughgoing apertures on the other end;
a transparent plastic cylindrical open ended caulking gun pouch secured to said linear belt member, an upper end of said cylindrical caulking gun pouch being provided with reinforcement means;
a loop member secured to said linear belt member;
a hammer loop assembly secured to said linear belt member, said hammer loop assembly comprising a support flap secured to said belt member and a loop member secured to said support flap;
a first rectangular transparent plastic pocket with a top opening, said first rectangular pocket having a flap secured to said belt member;
a second rectangular transparent plastic cutting tool pocket having a length longer than said first rectangular pocket secured to said belt member with an opening of said pocket being positioned above said first rectangular transparent plastic pocket top opening, said second rectangular pocket having a flap secured to said belt member; and
a transparent plastic paint brush pocket secured to said belt member, said paint brush pocket comprising a flap section and two stepped sections secured to said flap section, said stepped sections forming a wider open top section and an opened ended narrower bottom section, said sections forming a stepped chamber open on the wider top section to receive the bristle portion of a paint brush and open at the bottom on the narrower bottom section to receive a handle of a paint brush.

17. A painter's belt as claimed in claim 16 wherein said stepped chamber allows passage of a paint brush handle therethrough and stops passage of the bristle portion of a paint brush.

18. A painter's belt as claimed in claim 16 wherein, said pouches and pockets are constructed of two pieces of plastic stitched together.

19. A painter's belt as claimed in claim 16 wherein said hammer loop assembly loop member is positioned on the distal end of said support flap.
